(19) United States
(12) Patent Application Publication
(10) Pub. No.: US 2015/0302330 A1
(43) Pub. Date: Oct. 22, 2015

(54) Automated Job Assignment to Service Providers

(71) Applicants: Ron Banner, Haifa (IL); Mani FISCHER, Haifa (IL); Doron SHAKED, Tivon (IL)

(72) Inventors: Ron Banner, Haifa (IL); Mani FISCHER, Haifa (IL); Doron SHAKED, Tivon (IL)

(21) Appl. No.: 14/364,724

(22) PCT Filed: Mar. 5, 2012
(86) PCT No.: PCT/US2012/027730

§ 371 Date: Jun. 12, 2014

(51) Int. Cl. G06Q 10/06

(52) U.S. Cl. CPC G06Q 10/06311

(57) ABSTRACT

A system (100) can include a broker (110) to process a plurality of job requests (120) and automatically query for response parameters from a plurality of service providers (140) based on the plurality of job requests (120). An assignment function (150) can assign a job (130) associated with the plurality of job requests (120) to a service provider of the plurality of service providers (140) based on the received response parameters from the plurality of service providers (140) and based on balancing competing production interests across the plurality of service providers (140).

### BACKGROUND

Service providers deliver various services such as print service providers that offer print services, cable service providers that offer viewing services, and Internet service providers that offer network connection services, for example. As but one example, a print service provider is a technology business that offers printing services such as printing of promotional materials, business literature, business cards, books, magazines, and so forth. Substantially any type of service can be requested from the service provider who often competes with other providers to fulfill a given customer's needs. In some cases, an intermediate layer may assign an order from the customer to a respective service provider. Sometimes, the lowest cost provider is selected by the intermediate layer. In such cases, one provider may see substantially more business than another even though pricing is substantially similar. In another case, the least utilized provider may be selected to facilitate timely delivery to the customer.

### BRIEF DESCRIPTION OF THE DRAWINGS

FIG. 1 illustrates an example system for assigning print jobs to a network of service providers.

FIG. 2 illustrates an example processing system for automatic assignment or print jobs.

FIGS. 3-6 illustrate example print job assignments and the effects of combinatorial expansion for such assignments.

FIG. 7 illustrates an example assignment function and example constraints that are applied to the function to facilitate print job assignment.

FIG. 8 illustrates an example method for assigning print jobs to a network of providers.

### DETAILED DESCRIPTION

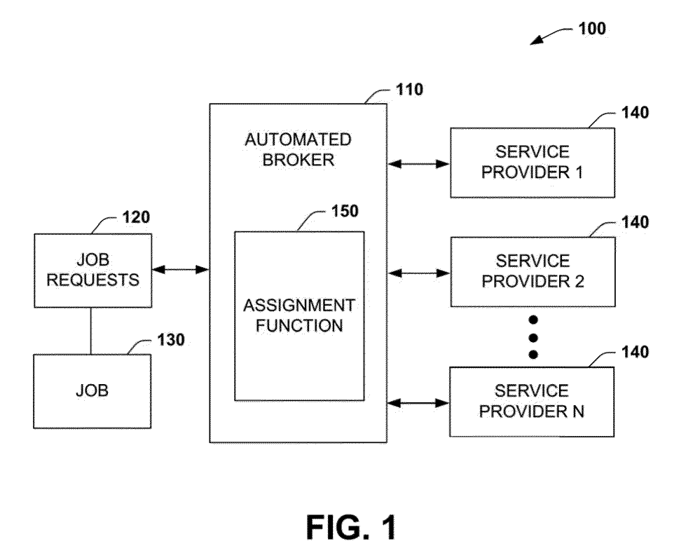

FIG. 1 illustrates an example system 100 for assigning jobs to a network of service providers. The system 100 includes an automated broker 110 to process job requests 120 and automatically query for response parameters from a plurality of service providers shown as service provider 1, service provider 2, and up to service provider N at 140, wherein N represents a positive integer. The job requests 120 can be generated from a plurality of prospective user's who in turn can generate a plurality of different jobs 130 (e.g., print jobs, other service requests) from different network locations. The job requests 120 can be communicated via an application programming interface that generates an electronic order from a network interface such as over the Internet. The job requests 120 typically specify quantities, desired pricing, billing information, shipping information, and so forth in addition to providing an electronic link to the associated job 130, wherein the job represents an electronic representation of data to be utilized in the job (e.g., printed). The response parameters received from the service providers 140 can be related to the service provider's ability to fulfill a job request 120 such as capacity, pricing, delivery schedules, alternative shipping arrangements, and considerations based on job type (e.g., one quote for business cards and a separate quote for letter head), for example.

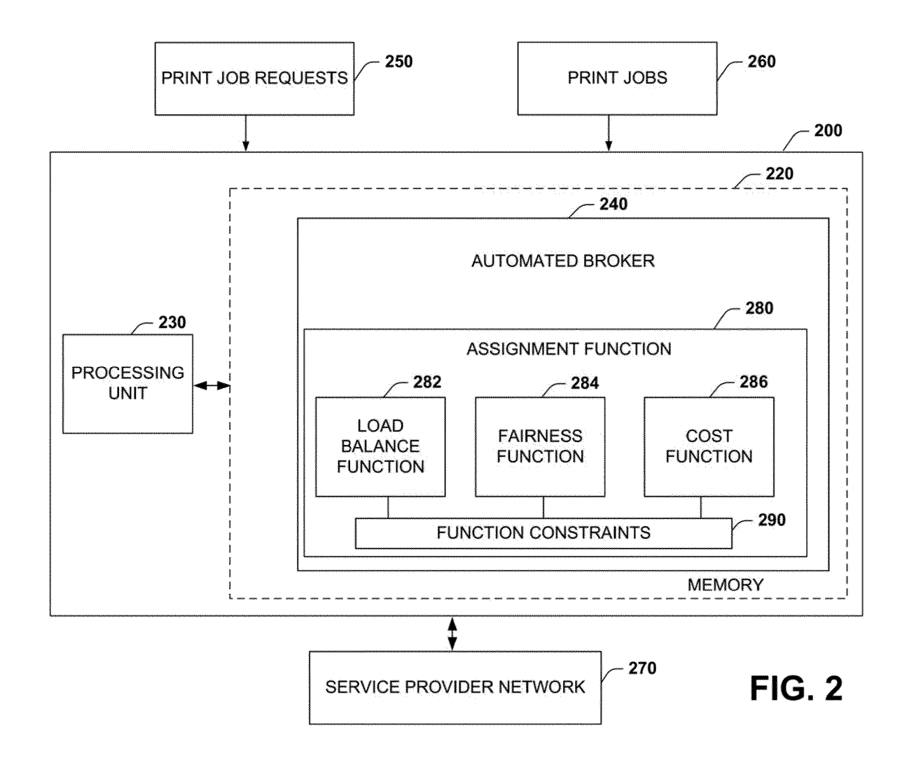

The broker 120 includes an assignment function 150, which can include a load balance function, a fairness function, and a cost function, among other aspects for example and will be described below with respect to FIG. 2. The assignment function 150 can assign the job 130 to one of the service providers 140 based on the received response parameters and to automatically balance competing production interests across the service providers 140. Thus, the broker 110 can query the respective providers 140 for response parameters such as current capacity, pricing information, delivery schedules, and so forth, for example. When the broker 110 receives such provider response parameters, the assignment function 150 can attempt to automatically balance competing interests such as balance production load across the service providers 140 in a concurrent manner. To further facilitate balancing of interests, the assignment function 150 can include a concurrent attempt to achieve fairness such that each provider 140 receives predictable workloads given reasonable pricing while attempting to mitigate costs to the broker 110 and also to mitigate costs for users that generate the request 120. In addition, the broker 110 can also utilize flexible quoting arrangements such as adjustable offers to determine print job assignments to the providers 140 such as offering jobs based on discounts (e.g., seeking fulfillment of large orders by offering price discount for bulk processing), time to fulfill an order (e.g., next job sent according to provider who can fulfill job in the next five hours), and substantially any modification/incentive to existing order protocols to facilitate order fulfillment and/or cost efficiencies.

In contrast to conventional systems that sought to optimize one variable such as cost or utilization at a time, the broker 110 can query the entire network of providers 140 and perform many assignments of jobs 130 to enhance the performance of the network, mitigate overall costs, improve fairness, and/or balance production load. This can be achieved by interest balancing features of the assignment function 150 that seek to maintain competitive equities across the network of providers 140 (e.g., facilitate that loads and work distribution are reasonably maintained) while concurrently improving cost efficiencies across the overall network.

In one example, the broker 110 can provide for automating the assignment between a set of jobs 130 and the set of service providers 140 considering various aspects (e.g., cost, fairness, order starvation, load balance, and so forth). In some cases, a company can operate the broker 110, process jobs 130, and assign the jobs to the service providers 140. The assignment should be performed automatically due to the sheer size of the problem and management of complex assignment variables as will be described below, wherein as service providers 140 are added to the network, the number of assignment solutions can exponentially increase.

At least three assignment problems can be considered where each assignment solution for such problems should at least account for: (1) “Cost”: job cost should be minimized; (2) “Fairness”: the distribution of jobs to service providers 140 should be fair, where very small price differences (e.g., defined by threshold) should not cause imbalanced shifts in production; and (3) “load balance”: the job distribution between service providers should be balanced. It can be shown that these problems are NP-hard meaning that no efficient running time algorithm exists to optimally solve these problems. To account for such complexity, the broker 110 formulates and processes a model generated from several problem definitions (described below with respect to FIG. 2) and provides optimal solutions that are scalable in practice (e.g., workable number of assignment solutions generated in view of an exponential number of assignment possibilities).

The problem definitions for assignment provide workable guidelines for obtaining assignment solutions. For example, given an instance that consists of a set of jobs 130 and a set of service providers 140, a feasible assignment can be considered an assignment where all jobs are assigned to service providers and all capacity limitations are met. The lowest cost assignment can be considered a feasible assignment that has the minimum total cost among all feasible assignments. Finally, given a budget constraint B (e.g., a budget that is 5% higher than the lowest assignment cost and individual production costs are less than 10% above the highest employed cost in the lowest assignment solution), A is considered a fair assignment (alternatively, balanced assignment) if A is feasible with total cost of at most B and no other feasible assignment A′ that satisfies the budget constraint B exists with Fairness(A′)>Fairness(A) (alternatively, Load (A′)<Load (A)), where:

$$Fairness ( A ) = {min}_{p ∈ Provider} \{ {utilization}_{p} \} ; Load ( A ) = {max}_{p ∈ Provider} \{ {utilization}_{p} \} .$$

The considered fairness and load balancing criteria can be extended as follows. For the fairness criterion, the provider with the lowest utilization can receive the maximum utilization. Under this constraint, the provider with the next lowest utilization should receive the maximal possible utilization, and so forth. In a similar manner, it is also possible to extend the load balancing criterion.

A challenge with the above problem definitions and associated modeling to establish a scalable solution that can efficiently assign a vast amount of jobs 130 (e.g., order of millions) to a large number of service providers 140 (e.g., dozens to thousands). It is straight-forward to show that the respective problems are NP complete (e.g., a reduction to the unsplittable flow problem). Moreover, with such order of magnitudes, the number of possible solutions can be exceedingly large (phenomena known as a combinatorial explosion). Therefore, it is generally not possible to employ exhaustive search approaches in one case, yet in another case, attempt simple approaches (e.g., greedy, round robin, and so forth) that produce results for such large instances that are fundamentally less attractive compared to the optimum.

For purposes of simplification of explanation, in the present example, various components of the system 100, such as the broker 110 and assignment function 150 are illustrated and described as performing different functions. However, one of ordinary skill in the art will understand and appreciate that the functions of the described components can be performed by different components, and the functionality of several components can be combined and executed on a single component. The components can be implemented, for example, as computer executable instructions (e.g., software, firmware), hardware (e.g., a CPU, an application specific integrated circuit), or as a combination of both. In other examples, the components could be distributed among remote devices across a network, for example. The executable instructions of the system 100 and other functions disclosed herein can be provided as a non-transitory computer readable medium having the computer executable instructions stored thereon.

FIG. 2 illustrates an example processing system 200 for automatic assignment or print jobs 210. Before proceeding, it is noted that FIG. 2 and the discussions that follow describe a particular example of print job processing. As described above, other types of services than printing are possible. The system 200 can be implemented with a memory for storing computer executable instructions and a processing unit 230 for accessing the memory and executing the computer executable instructions. The computer executable instructions in the memory 220 can include an automated broker 240 to process a print job request 250 for a print job 260 and automatically query a network of service providers 270 to receive response parameters to the print job request. An assignment function 280 can assign the print job 260 to a service provider (or providers) from the network of service providers 270 based on the received response parameters from the network of service providers and based on balancing competing production interests across the network of service providers.

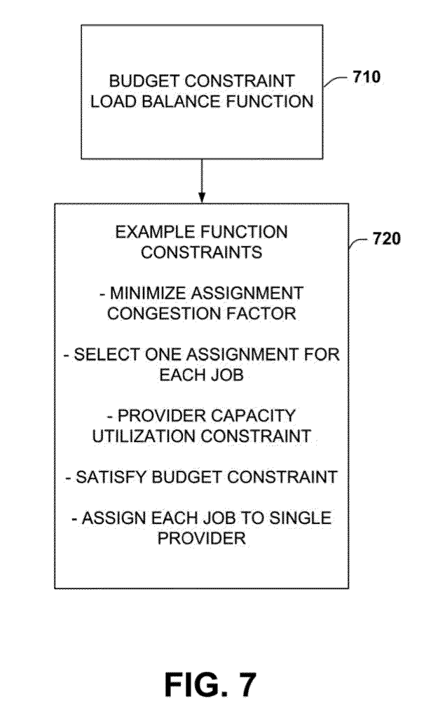

As shown, the assignment function 280 can include a load balance function 282, a fairness function 284, and a cost function 286 that all operate under function constraints 290 which are described below with respect to FIG. 7. The cost function 286 can be utilized to minimize overall costs across the network of service providers 270 by selecting a feasible assignment that has the lowest cost among feasible assignments. The load balance function 282 can minimize utilization of the highest loaded service provider from the network of service providers 270. The fairness function 284 can maximize utilization of the lightest loaded service provider.

The assignment function 280 and associated functions 282-286 can be constructed according to a job assignment model that can include various features that support the functionality described above with respect to the broker and assignment function for automatically assigning print jobs to service providers. Another model feature can include facilitating that print job deadlines are met. In some cases, this may include selecting a more expensive provider, for example, in view of the respective deadline. In yet another example feature, the model attempts to facilitate that distribution between providers is fair and regular.

In order to execute the job assignment model features, various problem definitions are given that seek to guide how the model is executed. For example, jobs can be assigned to providers such that overall costs are minimized. This might include increased costs for one transaction while mitigating costs for a group of transactions. In another example of model execution, jobs can be assigned to providers such that cost is maintained below a given threshold while fairness is maximized. Thus, even though one provider may offer services for slightly lower costs, as long as another is within a reasonable threshold of the maximal employed cost, then such provider would not be precluded from receiving orders from the automated broker 240.

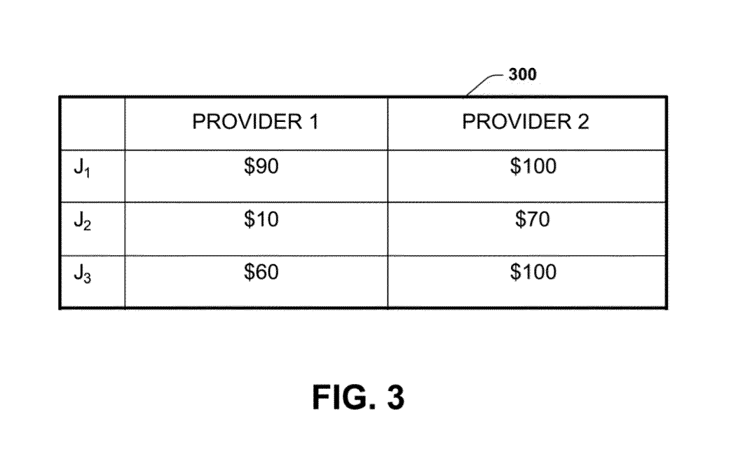

In yet another problem definition for model execution, jobs can be assigned such that cost is maintained below a given threshold while congestion among providers is minimized. Thus, print jobs should be spread among a network of providers to balance print load assignments. As will be shown below with respect to FIGS. 3-6, management of multiple providers in view of the problem definitions can be computationally challenging (e.g., NP Hard, where NP refers to non-polynomial and attempts to satisfy the problem definitions can yield exponential number of actions to provide a suitable solution).

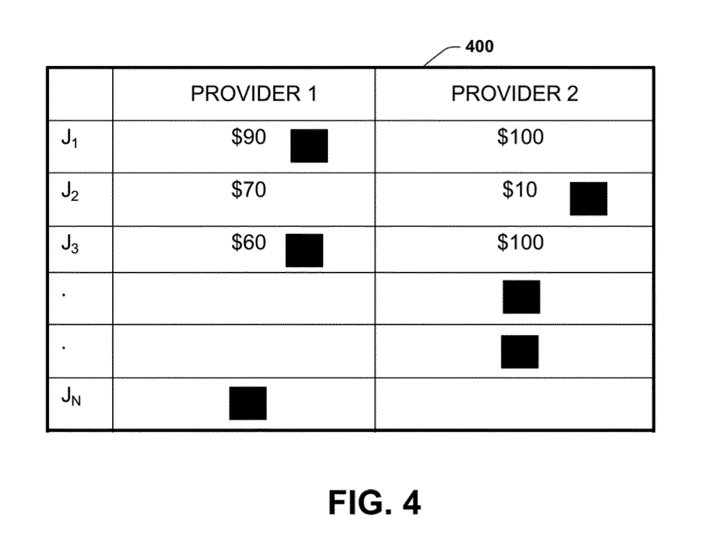

FIGS. 3-6 illustrate example print job assignments and, the effects of combinatorial explosion for such assignments. FIG. 3 illustrates a table 300 which shows columns for two service providers Provider 1 and Provider 2. Each row in the table 300 illustrates a price that is offered by each provider for a respective print job shown as J1, J2, and J3. All three jobs are for the printing of ten sample business cards by the following day. Provider 1 can produce at most, twenty cards by tomorrow. Provider 2 can produce at most thirty business cards by tomorrow. Now referring to FIG. 4, a cost matrix 400 is illustrated showing possible combinations for fulfilling the three jobs J1-J3 described in FIG. 3. As shown by the placement of black squares in the columns of the matrix 400, there are 2^{N} combinations to assign N print jobs to only two providers. Thus, when there are thousands of providers to manage, a staggering number of fulfillment combinations are possible. As will be shown below with respect to FIG. 7, a budget constraint load balance function can be provided along with various functional constraints to facilitate efficient selection and assignment of a service provider.

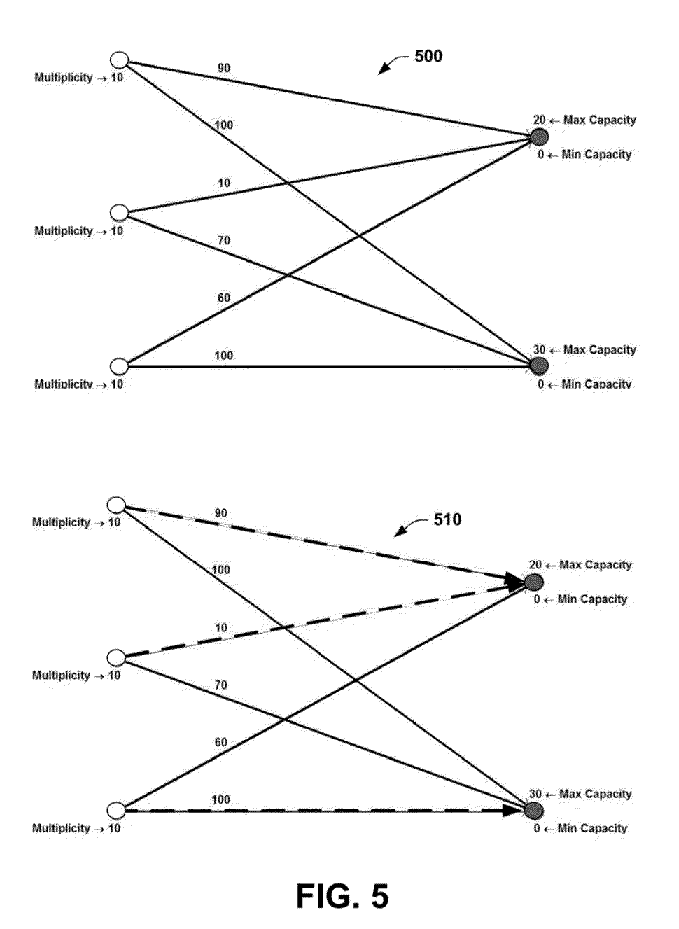

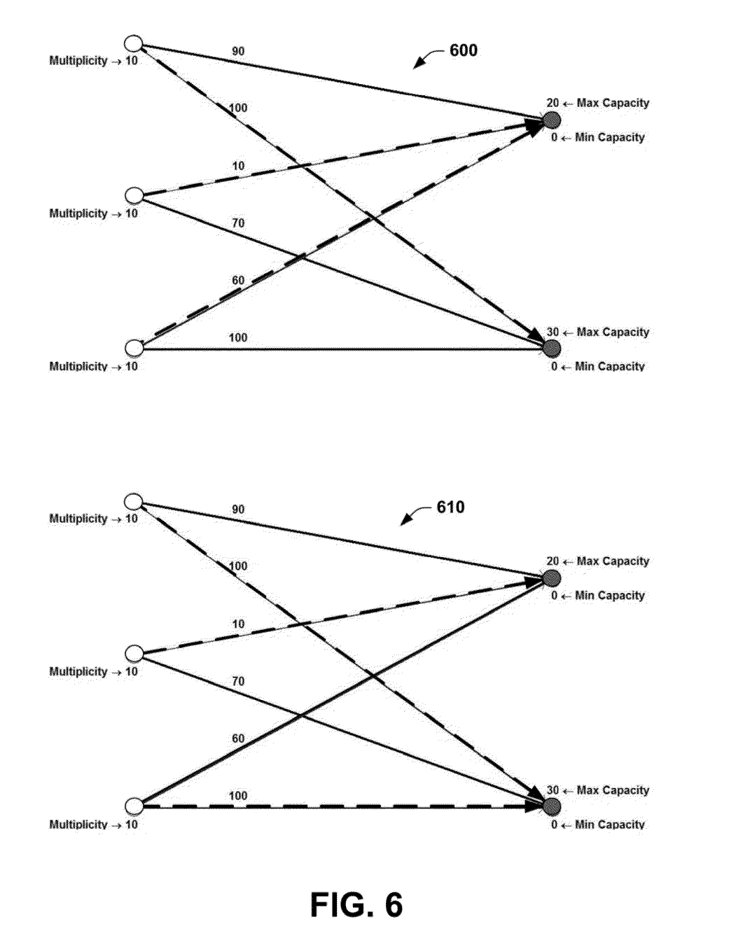

Before proceeding, example output graphs are shown in FIGS. 5 and 6 that outline possible solutions for selecting the provider examples depicted in FIG. 3. The white nodes on the left side of the bipartite graphs represent print jobs and their respective multiplicities. The gray nodes on the right side of the graphs represent the providers and their respective capacities. A link between a job and a provider represents a possible assignment. Each assignment has a cost which appears on the corresponding link between nodes. The examples show the lowest cost, balanced and fair assignments and mark the selected assignments via black dotted line. The example at 500 of FIG. 5 is a given instance of a solution. The example at 510 of FIG. 5 is a solution obtained by a greedy approach (e.g., cost is 200 and lowest provider utilization is 10/30). The example at 600 of FIG. 6 is an assignment solution obtained by cheapest assignment (e.g., cost is 170 and lowest provider utilization is 10/30). At 610 of FIG. 6, a solution obtained by the fair assignment with a budget that enables 30% deviation from the optimum cost is shown (e.g., cost is 210 and lowest provider utilization increases to 20/30). A plurality of other combinations and service provider solutions are possible other than the examples shown.

FIG. 7 illustrates a budget constraint load balance function 710 and example constraints 720 that are applied to the function to facilitate job assignment. The budget constraint load balance function 710 is a particular example of the assignment function described above. Before proceeding, some description is provided to discuss the mathematical notations of the budget constraint load balance function 710. Example mathematical notations are shown in Table 1:

TABLE 1

| Program Budget Constraint Load Balance (Provider, Jobs, | | |
|---|---|---|
| {cₑ}, {y}, B) | | |
| Minimize α | | (1) |
| Subject to: | | |
| ${\sum }_{e ∈ O ( j )}^{ } {x}_{e} = 1$ | ∀j ∈ J | (2) |
| ${\sum }_{e ∈ l ( p )}^{ } {x}_{e} \leq {cap}_{p} \cdot α$ | ∀p ∈ Provider | (3) |
| ${\sum }_{e ∈ O ( j )}^{ } {x}_{e} \cdot {c}_{e} \cdot {γ}_{j} \leq B$ | ∀j ∈ J | (4) |
| xₑ ∈ [0, 1] | ∀e ∈ O(j), ∀j ∈ J | (5) |

The example function outlined in Table 1 can be based on an Integer Programming Formulation (IPF). Given an assignment A, let α=Load(A). In addition, let xₑ be an indicator that is set to one if the link e=(jobi, Providerp) is in the assignment and zero otherwise. Assume that each potential link e=(jobi, Providerp) has a cost cₑ, where each job has a size γᵢ (e.g., 100 business cards) and each provider has a capacity capₚ (e.g., 1000 business cards). The variable B denotes the total budget that can be used for an assignment. For each job j in Jobs, denoted by O(j) is the set of links that emanate from j, and for each Provider p in Providers denoted by I(p) is the set of links that enter p. The problem can then be formulated as an integer program over the variables {{xₑ}, α} as specified in Table 1.

The budget constraint load balance function 710 shown at equation (1) of Table 1 minimizes the assignment congestion factor Load (A). At 720, various constraints for the budget constraint load balance function 710 are illustrated. One constraint shown at equation (2) of Table 1 facilitates that one assignment will be selected for each job. Another constraint shown at equation (3) of Table 1 is the provider capacity utilization constraint. It states, for each provider, that the sum of all job sizes should not exceed a fraction of the provider capacity; in particular, the maximum provider utilization should not be larger than the value of α. A constraint shown at equation (4) of Table 1 facilitates that the budget constraint is satisfied. Another constraint shown at equation (5) of Table 1 facilitates that each job can be assigned unsplittably to a single provider (e.g., it rules out non-feasible assignments).

The budget constraint load balance function 710 illustrated in Table 1 can be solved using commercially available integer programming solvers. The solution of the program {xₑ} constitutes the optimal assignment, where xₑ=1 indicates an assignment of job j to Provider p. In general, integer programming is an NP-hard problem. Therefore, the running time for a solution may be exponential in the worst case. Nonetheless, many efficient techniques can be employed such as branch and bound techniques and cutting plane approaches as well as efficient approximation algorithms that employ rounding techniques for linear programming relaxations. In particular, execution of a solution generally converges fast and efficiently to the global optimum.

The assignment techniques described above differ from conventional assignment problems in several respects. In one aspect, job demands were processed differently than described herein by assuming that the nodes over each side of the bipartite graphs such as shown in FIGS. 5 and 6 are identical. In the systems and methods described herein, the modeling considers that the nodes that represent the jobs on the left side of the bipartite graph induce different loads while the nodes that represent the providers on the right side have different capacities. Finally, conventional systems and methods do not consider fairness and load balancing objectives, whereas the methods described herein consider maximizing the least utilized provider (fairness) and minimizing the most utilized provider (load balancing), for example.

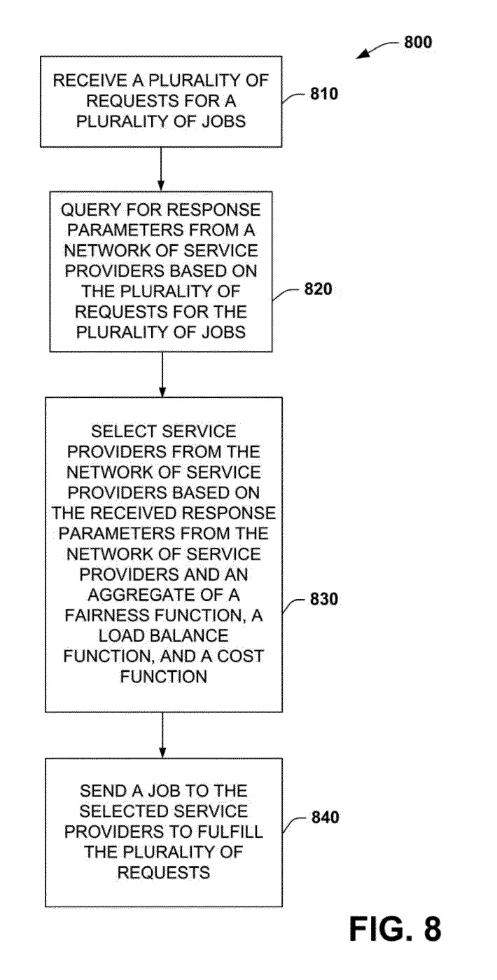

In view of the foregoing structural and functional features described above, an example method will be better appreciated with reference to FIG. 8. While, for purposes of simplicity of explanation, the method is shown and described as executing serially, it is to be understood and appreciated that the method is not limited by the illustrated order, as parts of the method could occur in different orders and/or concurrently from that shown and described herein. Such a method can be executed by a processor and associated equipment, for example.

FIG. 8 illustrates an example method 800 for assigning print jobs to a network of service providers. At 810, the method 800 includes receiving a plurality of requests for a plurality of jobs (e.g., request received via broker 110 of FIG. 1). At 820 of FIG. 1, the method 800 includes querying for response parameters from a network of service providers based on the plurality of requests for the plurality of jobs (e.g., via broker 110 of FIG. 1). At 830, the method 800 includes selecting service providers from the network of service providers based on the received response parameters from the plurality of service providers and an aggregate of a fairness function, a load balance function, and a cost function (e.g., via assignment functions 150 of FIG. 1). At 840, the method 800 includes sending the jobs to the selected service providers, by the processor, to fulfill the plurality of requests (e.g., via the broker 110 of FIG. 1).

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A system, comprising:
a broker to process a plurality of job requests and automatically query for response parameters from a plurality of service providers based on the plurality of job requests; and
an assignment function that assigns a job associated with the plurality of job requests to service providers of the plurality of service providers based on the received response parameters from the plurality of service providers and based on balancing competing production interests across the plurality of service providers.

2. The system of claim 1, wherein the jobs are print jobs and the plurality of service providers are print service providers.

3. The system of claim 1, wherein production interests of the assignment function includes a fairness function, a load balance function, and a cost function.

4. The system of claim 3, wherein the assignment function includes an adjustable offer function to alter job assignments to the plurality of service providers.

5. The system of claim 3, wherein the cost function minimizes overall costs across the plurality of service providers by selecting a feasible assignment that has the lowest cost among feasible assignments.

6. The system of claim 3, wherein the load balance function minimizes utilization of the highest loaded service provider

7. The system of claim 3, wherein the fairness function maximizes the least utilized service provider.

8. The system of claim 3, wherein the assignment function includes a constraint to facilitate that an assignment solution is selected from a plurality of assignment solution possibilities.

9. The system of claim 8, wherein the constraint facilitates that one assignment of a job is selected for each job.

10. The system of claim 8, wherein the constraint specifies that for each service provider that the sum of all job sizes does not exceed a fraction of service provider capacity.

11. The system of claim 8, wherein the constraint facilitates that a budget threshold is maintained or that each job is assigned unsplittably to a single service provider.

12. A method, comprising:
receiving a plurality of requests for a plurality of jobs;
querying, by a processor, for response parameters from a network of service providers based on the plurality of requests for the plurality of jobs;
selecting service providers from the network of service providers, by the processor, based on the received response parameters from the network of service providers and an aggregate of a fairness function, a load balance function, and a cost function; and
sending a job to the selected service providers, by the processor, to fulfill the plurality of requests.

13. The method of claim 12, wherein the load balance function minimizes utilization of the highest loaded service provider.

14. The method of claim 12, wherein the fairness function maximizes the least utilized service provider.

15. A system, comprising:
a memory for storing computer executable instructions; and
a processing unit for accessing the memory and executing the computer executable instructions, the computer executable instructions comprising:
a broker to process job requests for jobs and automatically query a network of service providers to receive response parameters to the job requests;
an assignment function that assigns the jobs to a service provider from the network of service providers based on the received response parameters from the network of service providers and based on balancing competing production interests across the network of service providers, wherein the assignment function includes:
a cost function to minimize overall costs across the network of service providers by selecting a feasible assignment that has the lowest cost among feasible assignments;
a load balance function to minimize utilization of the highest loaded service provider and maximizes utilization of the lightest loaded service provider; and
a fairness function to select a lowest cost service provider within a budget threshold in order to balance job loading among the network of service providers.
